(19) United States
(12) Patent Application Publication
(10) Pub. No.: US 2004/0187665 A1
(43) Pub. Date: Sep. 30, 2004

(54) Machine for continuous-cycle shearing of moving welded tubes

(75) Inventor: Aleardo Chezzi, Boretto (IT)

Correspondence Address: YOUNG & THOMPSON, 745 SOUTH 23RD STREET 2ND FLOOR, ARLINGTON, VA, 22202

(73) Assignee: OTO MILLS S.P.A., BORETTO (REGGIO EMILIA) (IT)

(21) Appl. No.: 10/799,650

(22) Filed: Mar. 15, 2004

(30) Foreign Application Priority Data
Mar. 27, 2003 (IT) M02003A000087

(51) Int. Cl. B26D 1/60

(52) U.S. Cl. 83/318; 83/54

(57) ABSTRACT

The machine comprises: a conveyor system for continuous supply of a tube at a constant velocity and in a longitudinal direction of the tube; a cutting slide which bears a shearing device predisposed to section the tube transversally and in successive tracts thereof; elements for activating which impose a linear alternating motion on the cutting slide without stopping, between an initial position and a final position along a parallel direction with respect to the longitudinal direction. The motion comprises an outward run, at least a tract of which occurs in synchrony with an advancement of the tube and during which the tube is sectioned, and a return run, following which the cutting slide is brought back to the initial position. Both the outward return runs comprise an acceleration tract, a constant velocity tract and a deceleration tract.

### BACKGROUND OF THE INVENTION

Machines of this type are usually applied in production lines for welded tubes. The lines continuously produce tubes starting from reels of steel ribbon (or other materials). The ribbon has a breadth which is equal to the circumference, or generally speaking the peripheral development of the tube to be manufactured and is wound on a reel positioned at a start of a line, at an unreeling station. The immediately subsequent station to the unreeling station is a facing machine at which at the end of the reel the ribbon is welded to the start of the next reel. The ribbon is then wound on an accumulator which allows enough time for the reels to be spliced and be unwound continuously. From the accumular the ribbon passes on to the forming machine, where a series of forming heads bend the ribbon longitudinally until it takes on a tube-shape, and is then closed by longitudinal welding made along the generatrix of the tube, where the side edges of the ribbon touch. Once the welding waste has been cleaned away, in a continuous operation, the tube goes to the cutting machine, where it is transversally sectioned and made into a series of tubes of a desired length.

The shearing machine typically comprises a conveyor for continuously transporting the welded tube parallel to which a slide bearing the cutting devices runs in a continuous forward-backward movement; the cutting device is generally a mill. The shearing operation is done at a tract of the outward run of the slide, during which the slide moves at a same velocity as the tube. Once the cutting operation has been concluded, the slide reverses and performs a return run, immediately commencing an outward run so as to make another cutting operation on the moving tube.

During both the outward and return runs the slide experiences an acceleration stage, a constant-velocity stage and a deceleration stage, at the end of which movement direction is inverted. The speed/time parameter is trapezoid, with an acceleration ramp, a constant-speed horizontal tract and a descending deceleration tract. To limit bumps and vibrations on the system, the accelerations of the slide have to be limited, opting for a motion profile in which the acceleration is progressive and continuous over time. For this purpose the passages, from the acceleration tract to the constant speed tract and then to the deceleration tract are “softened” with second-degree polynomial curves, which produce a speed profile which, when derived, gives a trapezoid acceleration profile.

A trapezoid acceleration profile does not however sufficiently limit bumps and vibration on the system, especially in the most common applications in which the motion is transmitted to the slide by a belt. The intrinsic elasticity of the belt causes elastic energy accumulation and release problems, especially during the slide deceleration stages, when the belt “relaxes”, and then when the acceleration stage begins and there are build-ups leading to problems of inertia mass control. These phenomena cannot be attenuated with trapezoid acceleration profiles.

The main aim of the present invention is to provide a machine for speed-shearing in welded tubes in a continuous cycle, which overcomes the above-cited drawbacks.

An advantage of the machine of the invention is that it keeps bumps and vibrations down to a minimum in view of the geometry and dynamics of the cut.

### SUMMARY OF THE INVENTION

The machine comprises: a conveyor system for continuous supply of a tube at a constant velocity and in a longitudinal direction of the tube; a cutting slide which bears a shearing devices predisposed to section the tube transversally and in successive tracts thereof; means for activating which impose a linear alternating motion on the cutting slide without stopping, between an initial position and a final position along a parallel direction with respect to the longitudinal direction of transport of the tube. The motion comprises an outward run, from the initial position to the final position, at least a tract of which occurs in synchrony with an advancement of the tube and during which the tube is sectioned, and a return run, following which the cutting slide is brought back into the initial position. Both the outward run and the return run comprise an acceleration tract, a constant velocity tract and a deceleration tract. The means for activating impose on the cutting slide an alternating linear motion with no stops following a law of motion in which acceleration is a derivable function.

### BRIEF DESCRIPTION OF THE DRAWINGS

Further characteristics and advantages of the present invention will better emerge from the detailed description that follows of a preferred but non-exclusive embodiment of a machine for continuous-cycle shearing of moving welded tubes, illustrated purely by way of a non-limiting example in the accompanying figures of the drawings, in which:

FIG. 1 is a simplified perpective-view diagram of the machine;

FIG. 2 shows sample graphs relating to time/velocity, acceleration and jerk;

FIG. 3 shows some comparison graphs demonstrating errors of position, speed and acceleration in view of a traditional law of motion (a) and a law of motion according to the present invention (b).

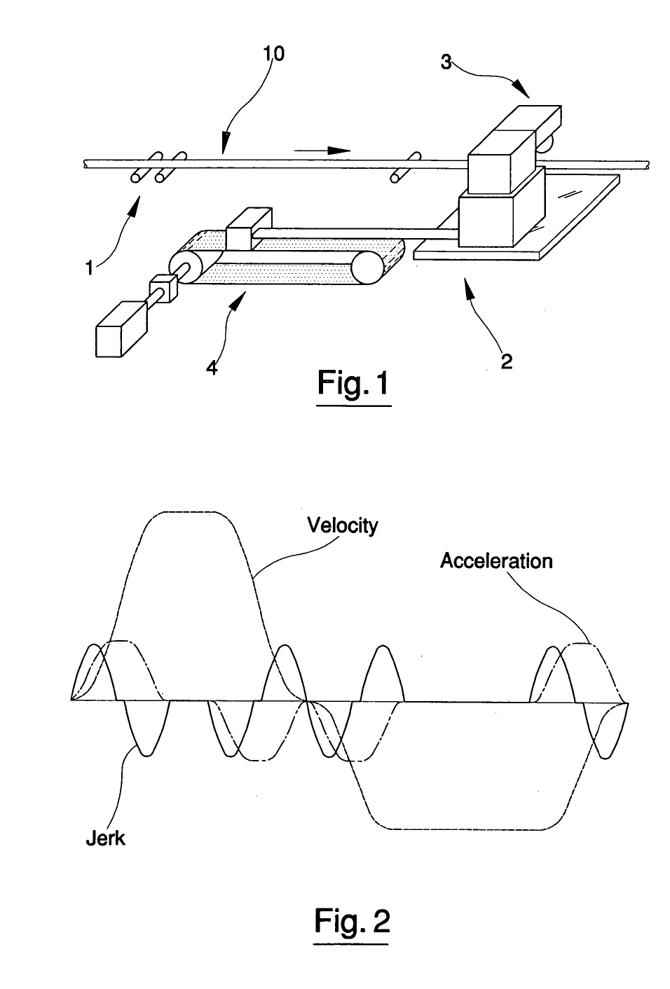

### DESCRIPTION OF THE PREFERRED EMBODIMENTS

As previously described, the machine makes a running shear, i.e. the cut is performed on a tube 10 which is in continuous motion at a constant speed. The machine therefore comprises a conveyor system 1 for the continuous and constant-speed travel of the tube 10 in a longitudinal direction thereof, and a cutting slide 2 which supports shearing devices 3 for transversally sectioning the tube 10 into successive tracts of tube. The cutting slide 2 is controlled by means for activating 4 which cause the slide to move in a linear direction which is parallel to the longitudinal motion direction of the tube 10. The motion is continuous between an initial position and a final position and comprises an outward run, from the initial position to the final position, at least a tract of which is in synchrony with the tube advancement speed, during which tract the tube 10 is sectioned, and a return run, following which the cutting slide 2 is brought back into the initial position. Both the outward run and the return run comprise a tract of acceleration, a constant-velocity tract and a tract of deceleration.

A cutting cycle begins from the initial position of the cutting slide 2. From here the cutting slide 2 accelerates up until it reaches the tube 10 motion speed. Once this speed has been reached, the cutting slide is in synchrony with the tube 10, effectively moving at the same speed thereas. The shearing devices 3 start the transversal cut of the tube 10, which is performed while the tube 10 is moving. Once the cut has been completed, the cutting slide 2 slows down until it actually changes direction, i.e. at an endrun point thereof. Without pausing, the cutting slide 2 begins the return run, which is done at a constant velocity with an initial acceleration and a final deceleration, up until the initial position is once more reached, and the whole cycle recommences.

To limit the bumps and vibrations on the machine and the transmission system in particular, the accelerations the moving parts are subjected to have to be limited, and especially brusque or jerky accelerations have to be avoided. In the law of motion imposed on the slide acceleration is a derivable function and the derivation, i.e. the jerk is in fact a continuous process. Advantageously the motion imposed on the cutting slide 2 includes a velocity profile on the basis of which the passages from the acceleration tracts to the constant velocity tracts and thence to the deceleration tracts connect with sinusoidal curves. In a further embodiment a similar motion imposed on the cutting slide 2 includes a velocity profile on the basis of which the passages from the acceleration tracts to the constant velocity tracts and thence to the deceleration tracts connect with seventh-degree polynomial curves.

The theoretical law of motion, which exhibits the above-cited characteristics, becomes concrete motion with effective and determined velocity and acceleration values by means of a microprocessor which is connected to or integrated with the means for activating 4. To correctly define the law of motion at least five fundamental parameters are needed: the maximum run available for the cutting slide 2; the maximum acceleration that can be imposed on the cutting slide 2; the length of the material to be cut; the maximum return velocity that can be imposed on the cutting slide 2. Starting from the above data, from the signal of an encoder detecting the velocity and the position of the material to be cut (tube or profile), and from the signal of an encoder which detects the velocity and position of a motor which accelerates the cutting slide 2, the microprocessor defines a law of motion in which the cut is made at the maximum possible line velocity. In particular, among the results obtained by the microprocessor, the value of the acceleration space of the outward run is very important, which coincides with the deceleration space of the return run. After the acceleration space there is the space during which the cutting slide 2 runs at a constant velocity and during which the cut is effected. This corresponds to the line speed multiplied by the cutting time. The outward run is terminated by the deceleration stage, which is followed by the return run, optimized for the end of the cycle i.e. the return run is terminated at exactly the moment at which a new outward run commences.

To illustrate what is described above, FIG. 2 shows a graph evidencing the velocity, acceleration and jerk profiles relating to the curve of motion described. As can be seen the progresses of the three elements are continuous over time and are free of brusque variations. I

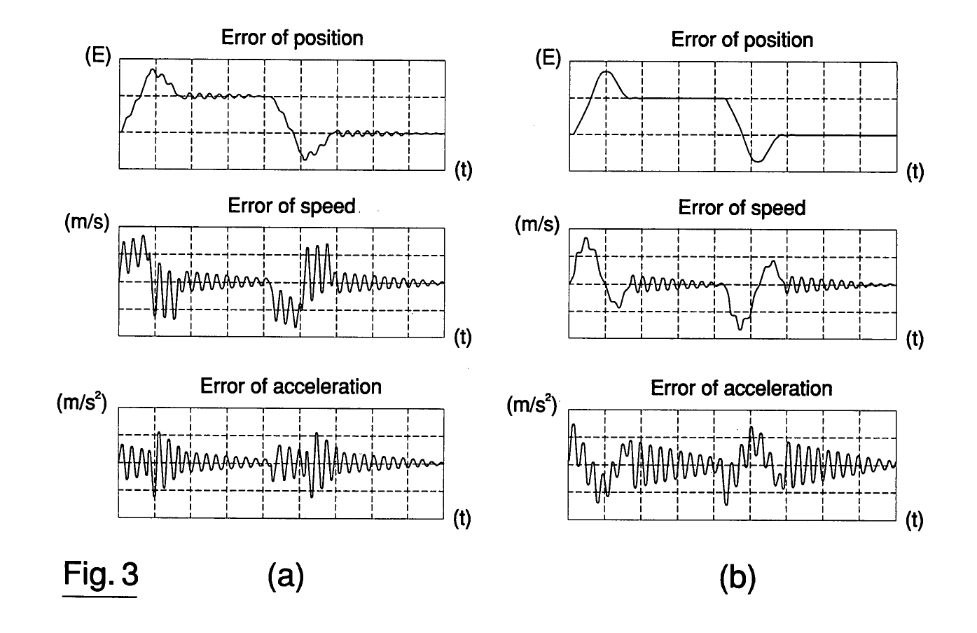

To demonstrate the advantages obtainable from the use of the invention with respect to the prior art, FIG. 3 shows a comparison between some simulation graphs of traditional motion with trapezoid velocity profiles connected with second-degree polynomial curves (curves a) and the law of motion according to the present invention, with trapezoid velocity profiles connected with sinusoidal curves (curves b).

The graphs illustrate the position, velocity and acceleration errors which indicate the stability and system-response readiness. From an analysis of the graphs it can be seen how in the curve of motion of the present invention the oscillations of position and velocity, which translate into machine vibrations, are considerably smaller than those of the prior art.

The invention offers important advantages. Firstly, it enables optimisation of the slope of all the acceleration and deceleration ramps, so that during the cycle only the minimum accelerations are necessary. This means a considerable reduction in the machine's energy consumption, and also a reduction in the mechanical stress on the transmission system and the machine. The invention also enables an optimisation of the return velocity, reducing it to the minimum necessary for closing the cycle. A further important advantage is the “softness” of the acceleration and deceleration ramps, with a consequent elimination of discontinuities of acceleration during inversion of direction.

What is claimed:

1). A machine for continuous-cycle shearing of moving welded tubes, comprising:
a conveyor system for continuously supplying a tube at a constant velocity and in a longitudinal direction of the tube;
a cutting slide which bears shearing devices predisposed to section the tube transversally and in successive tracts thereof;
means for activating which impose a linear alternating motion on the cutting slide without pausing, between an initial position and a final position along a parallel direction with respect to the longitudinal direction of transport of the tube; the linear alternating motion comprises an outward run, from the initial position to the final position, at least a tract of which occurs in synchrony with an advancement of the tube and during which the tube is sectioned, and a return run, following which the cutting slide is brought back into the initial position; both the outward run and the return run comprise an acceleration tract, a constant velocity tract and a deceleration tract;
wherein the means for activating impose on the cutting slide an alternating linear motion with no pauses following a law of motion in which acceleration is a derivable function.

2). The machine of claim 1, wherein the law of motion imposed on the cutting slide, the derived acceleration function progresses continuously over time.

3). The machine of claim 1, wherein the law of motion imposed on the cutting slide includes a velocity profile in which passages from the acceleration tract to the constant-velocity tract and passages from the constant-velocity tract to the deceleration tract occur with sinusoidal curves of connection.

4). The machine of claim 1, wherein the law of motion imposed on the cutting slide includes a velocity profile in which passages from the acceleration tract to the constant-velocity tract and passages from the constant-velocity tract to the deceleration tract occur in seventh-degree polynomial curves of connection.
